(19) United States
(12) Patent Application Publication
(10) Pub. No.: US 2015/0167842 A1
(43) Pub. Date: Jun. 18, 2015

(54) SHIFTING MANIPULATION APPARATUS FOR VEHICLE

(71) Applicant: Hyundai Motor Company, Seoul (KR)

(72) Inventor: Bong Guy Son, Gunpo-si (KR)

(73) Assignee: Hyundai Motor Company, Seoul (KR)

(21) Appl. No.: 14/477,698

(22) Filed: Sep. 4, 2014

(30) Foreign Application Priority Data
Dec. 18, 2013 (KR) 10-2013-0158743

(51) Int. Cl. F16H 63/04; F16H 61/02

(52) U.S. Cl. CPC F16H 63/04; F16H 61/0293

(57) ABSTRACT

A shifting device for a vehicle may include a control rod disposed on a support and being configured to rotate and slide straight, a shift lever mounted on the control rod to rotate the control rod about the support by moving straight, a driven arm disposed on the support and rotatable about a rotation axis parallel to the control rod, an inertial body disposed at a free end of the driven arm, and an arm rotating mechanism engaging the shift lever and the driven arm to transmit a rotation of the shift lever to the driven arm.

### CROSS-REFERENCE TO RELATED APPLICATION

The present application claims priority to Korean Patent Application No. 10-2013-0158743 filed on Dec. 18, 2013, the entire contents of which is incorporated herein for all purposes by this reference.

### BACKGROUND

1. Field of the Invention

The present invention relates to a shifting device for a vehicle, and more particularly to the structure of a shift lever of a manual transmission.

2. Description of Related Art

Manual transmissions shift to the gears that a driver wants by transmitting a force for operating a shifting lever applied by the driver to a select lever and a shift lever through a cable.

FIG. 1 shows a portion of a shifting device of the related art, which includes a select lever 500 receiving a selecting force applied by a driver, a shift lever 502 receiving a shifting force, and a control rod 506 moved up/down in the figure by the selecting force and shifting to a shifting finger 504 by being rotated by the shifting force.

In particular, an inertial body 508 is integrated with the shift lever 502 to allow for smooth shifting without locking in shifting, so the inertial amount of the shift lever 502 is increased.

However, the inertial body 508 fixed to the shift lever 502, as described above, is designed to apply a predetermined inertia force to the shift lever 502 regardless of the movement of the shift lever 502, so that there is a limit in improving the comfort in shifting and it causes a shifting shock and unsmooth operation due to excessive inertia at the end of shifting.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a shifting device for a vehicle which can allow for smooth, easy, comfortable, and stable shifting without locking in shifting, and particular, which can improve shifting comport in a vehicle by considerably reducing a shock due to inertia force at the end of shifting.

In an aspect of the present invention, a shifting device for a vehicle may include a control rod disposed on a support and being configured to rotate and slide straight, a shift lever mounted on the control rod to rotate the control rod about the support by moving straight, a driven arm disposed on the support and rotatable about a rotation axis parallel to the control rod, an inertial body disposed at a free end of the driven arm, and an arm rotating mechanism engaging the shift lever and the driven arm to transmit a rotation of the shift lever to the driven arm.

The arm rotating mechanism may include an oblong hole radially formed at the shift lever, and a connecting pin fixed to the driven arm and inserted in the oblong hole to be engaged thereto.

The connecting pin is fixed to the driven arm between the rotation axis of the driven arm and the inertial body.

The oblong hole of the shift lever is shaped with a width gradually increasing inward in a radial direction from a distal end of the shift lever, and shoes protrude from an inner surface of the oblong hole, the shoes elastically supporting the connecting pin on a portion where the shift lever comes in contact with the connecting pin at the end of shifting.

The shoes of the oblong hole are formed in shapes of elastic plate that are gradually spaced from both sides of the inner surface in the oblong hole inward from the distal end of the shift lever, and are elongated with a diameter of the connecting pin maintained.

According to the present invention, smooth, easy, comfortable, and stable shifting can be achieved without locking in shifting, it is possible to improve shifting comport in a vehicle by considerably reducing a shock due to inertia force at the end of shifting.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing the configuration of a shifting device according to the related art.

FIG. 2 is a view showing the configuration of a shifting device according to an exemplary embodiment of the present invention.

FIG. 3 is a view showing in detail the control lever, the connecting pin, and the oblong hole shown in FIG. 2.

FIG. 4 is a graph for comparing the effect of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

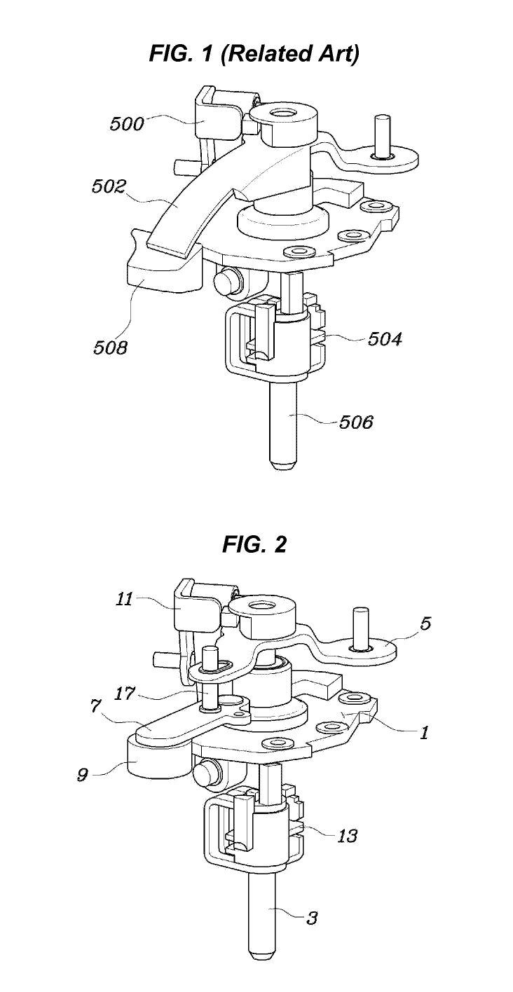

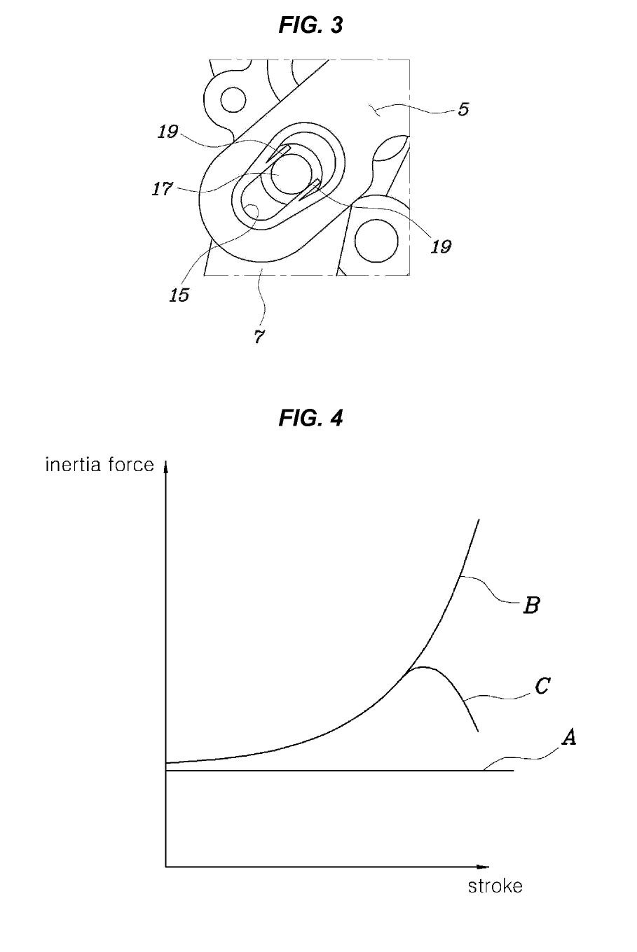

Referring to FIGS. 1 to 3, an exemplary embodiment of a shifting device for a vehicle according to an exemplary embodiment of the present invention includes, a control rod 3 disposed on a support 1 to be able to rotate and slide straight, a shift lever 5 mounted on the control rod 3 to rotate the control rod 3 about the support 1 by moving straight, a driven arm 7 disposed on the support 1 to be able to rotate about the axis parallel to the control rod 3, an inertial body 9 disposed at the free end of the driven arm 7, and an arm rotating mechanism transmitting the rotation of the shift lever 5 to the driven arm 7.

That is, in an exemplary embodiment of the present invention, unlike the related art, the inertial body 9 is not directly fixed to the shift lever 5, but inertia force is indirectly applied to the shift lever 5 through the specific driven arm 7. Accordingly, the inertia force exerted for the entire rotational stroke of the shift lever 5 appropriately changes in accordance with the geometrical position relationship between the rotation axis of the driven arm 7 and the arm rotating mechanism, so that smooth shifting can be achieved without locking by relatively small force, and particularly, inertia force causing a shock is prevented at the end of shifting, and thus the shifting comport of a vehicle can be maximized.

The support 1 may be a transmission case or cover and has a selecting lever 11 that can slide up/down the control rod 3 using a selecting force by a driver other than the configuration described above, and the control rod 3 has a shifting finger 13 for actual shifting.

In the present embodiment, the arm rotating mechanism includes an oblong hole 15 radially formed at the shift lever 5 and a connecting pin 17 fixed to the driven arm 7 and inserted in the oblong hole 15.

The connecting pin 17 is fixed to the driven arm 7 between the rotation axis of the driven arm 7 and the inertial body 9. Further, the rotation axis of the driven arm 7 is disposed radially outside from the control rod 3 that is the rotation axis of the shift lever 5.

Accordingly, as the shift lever 5 is rotated, the connecting pin 17 moves inward from outside the oblong hole 15, and applies the inertia force of the inertial body 9 to the shift lever 5.

The oblong hole 15 of the shift lever 5 is shaped with the width gradually increasing inward from the radial outside of the shift lever 5 and shoes 19, which elastically support the connecting pin 17 on the portion where the shift lever 5 comes in contact with the connecting pin 17 at the end of shifting, are disposed in the oblong hole 15.

In the present embodiment, the shoes 19 of the oblong hole 15 are formed in the shapes of elastic plate that are gradually spaced from both sides of the oblong hole 15, inward from the radial outside of the shift lever 5 in the oblong hole 15, and are elongated with the diameter of the connecting pin 17 maintained.

Accordingly, in shifting, the connecting pin 17 gradually moves inward in the oblong hole 15 from the outer side of the oblong hole 17 and the connecting pin 17 is positioned where the elastic plates that are the shoes 19 are spaced from both sides of the oblong hole 15 at the end of shifting. Further, the inertia force applied to the shift lever 5 through the driven arm 7 and the connecting pin 17 from the inertial body 9 due to sudden stop of the shift lever 5 is attenuated by the shoes 19, so that the inertia force actually applied to the shift lever reduces than that before.

That is, as compared in FIG. 4, when the inertial body 9 is fixed to the shift lever 5 as in the related art, the inertia force to the rotational stroke of the shift lever 5 is constant regardless of an increase in rotational stroke as indicated by the horizontal line A, and when the inertial body 9 is separated from the shift lever 5 through the driven arm 7 without the shoes 19, the inertia force applied to the shift lever 5 in geometric progression with an increase in rotational stroke as indicated by B. However, when the inertia force at the end of shifting is attenuated by the shoes 19, in an exemplary embodiment of the present invention, the inertia force increases with an increase in rotational stroke and rapidly decreases at the end of shifting, as indicated by C.

Accordingly, by using the shifting device for a vehicle according to an exemplary embodiment of the present invention, shifting can be made smoothly without locking due to inertia force and excessive inertia force can be suppressed by the elastic structure of the oblong hole 15 and the shoes 19 at the end of shifting. Therefore, it is possible to prevent a shifting shock and improve shifting comfort, which significantly contribute to improving the commercial value of a vehicle.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A shifting device for a vehicle comprising:
a control rod disposed on a support and being configured to rotate and slide straight;
a shift lever mounted on the control rod to rotate the control rod about the support by moving straight;
a driven arm disposed on the support and rotatable about a rotation axis parallel to the control rod;
an inertial body disposed at a free end of the driven arm; and
an arm rotating mechanism engaging the shift lever and the driven arm to transmit a rotation of the shift lever to the driven arm.

2. The shifting device of claim 1, wherein the arm rotating mechanism includes:
an oblong hole radially formed at the shift lever; and
a connecting pin fixed to the driven arm and inserted in the oblong hole to be engaged thereto.

3. The shifting device of claim 2, wherein the connecting pin is fixed to the driven arm between the rotation axis of the driven arm and the inertial body.

4. The shifting device of claim 3,
wherein the oblong hole of the shift lever is shaped with a width gradually increasing inward in a radial direction from a distal end of the shift lever, and
wherein shoes protrude from an inner surface of the oblong hole, the shoes elastically supporting the connecting pin on a portion where the shift lever comes in contact with the connecting pin at the end of shifting.

5. The shifting device of claim 4, wherein the shoes of the oblong hole are formed in shapes of elastic plate that are gradually spaced from both sides of the inner surface in the oblong hole inward from the distal end of the shift lever, and are elongated with a diameter of the connecting pin maintained.
